(19) United States
(12) Patent Application Publication
(10) Pub. No.: US 2023/0418486 A1
(43) Pub. Date: Dec. 28, 2023

(54) CONFIGURATION OF NEW STORAGE DEVICES IN A STORAGE DEVICE POOL

(71) Applicant: Western Digital Technologies, Inc., San Jose, CA (US)

(72) Inventors: Amit Sharma, Bangalore (IN); Dinesh Kumar Agarwal, Bangalore (IN)

(21) Appl. No.: 17/851,566

(22) Filed: Jun. 28, 2022

(51) Int. Cl. G06F 3/06

(52) U.S. Cl. CPC G06F 3/0632; G06F 3/0604; G06F 3/0679

(57) ABSTRACT

Aspects directed towards configuring new storage devices in a storage device pool are provided. In one aspect, a storage management device receives optimization information that includes at least one optimization learned by at least one source data storage device while part of a data storage system. A new data storage device for the data storage system is then configured with the at least one device optimization. In another aspect, a data storage device receives optimization information from a storage management device coupled to a plurality of pooled data storage devices, which includes the data storage device and at least one source data storage device. For this aspect, the optimization information includes at least one optimization learned by the at least one source data storage device while coupled to the storage management device. The data storage device is then configured to include the at least one device optimization.

### FIELD

The subject matter described herein relates to data storage devices. More particularly, the subject matter relates, in some examples, to the configuration of new storage devices in a storage device pool.

### INTRODUCTION

Data storage devices, such as solid-state devices (SSDs), can be pooled into storage pools. This type of storage virtualization is used in various information technology (IT) infrastructures. In principle, a storage pool includes multiple storage devices pooled together to form a virtual storage pool (VSP), eliminating the need to communicate with each storage device individually and collectively providing larger overall capacity. VSPs offer many advantages such as effective utilization of various storage medias and ease of access to storage media. At the same time, each individual SSD is a standalone entity, so the various SSDs in a VSP may have different firmware and/or hardware architectures.

New SSDs are often added to a VSP for various reasons. For instance, as an SSD in a VSP nears the end of its lifetime (e.g., as it nears a threshold number of Program Erase Cycles), it is typically replaced with a new SSD in which valid data from the old SSD is copied to the new SSD. Also, instead of replacing an SSD, it is sometimes desirable to simply add storage media to a storage pool to increase storage capacity. It should be noted that, when a new SSD is added to a VSP, the firmware of the new SSD generally has the factory/manufacturer default settings which may not be optimal for the storage pool. Accordingly, improved techniques for adding new SSDs to a VSP are desirable.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

One aspect of the disclosure provides a data storage system, including: a plurality of data storage devices each including a non-volatile memory (NVM), and a storage management device configured to: receive optimization information from at least one source data storage device of the plurality of data storage devices, in which the optimization information includes at least one optimization learned by the at least one source data storage device while part of the data storage system; and configure a new data storage device for the data storage system with the at least one device optimization.

Another aspect of the disclosure provides a method for use with a data storage system including a storage management device configured to couple to a plurality of data storage devices each including an NVM, the method including: receiving optimization information from at least one source data storage device of the plurality of data storage devices, in which the optimization information includes at least one optimization learned by the at least one source data storage device while part of the data storage system; and configuring a new data storage device for the data storage system with the at least one device optimization.

Another aspect of the disclosure provides a data storage system, including: a plurality of data storage devices each including an NVM; means for receiving optimization information from at least one source data storage device of the plurality of data storage devices, in which the optimization information includes at least one optimization learned by the at least one source data storage device while part of the data storage system; and means for configuring a new data storage device for the data storage system with the at least one device optimization.

In another aspect of the disclosure, a data storage device is provided, which includes: an NVM and a processor coupled to the NVM in which the processor is configured to: receive optimization information from a storage management device coupled to a plurality of pooled data storage devices including the data storage device and at least one source data storage device, in which the optimization information includes at least one optimization learned by the at least one source data storage device while coupled to the storage management device; and configure the data storage device to include the at least one device optimization.

### BRIEF DESCRIPTION OF THE DRAWINGS

FIG. 1 is a schematic block diagram illustrating an exemplary data storage system including a storage management device configured to optimize new data storage devices (DSDs) added to a storage device pool based on optimizations learned by existing DSDs in accordance with some aspects of the disclosure.

FIG. 2 is a graph comparing an optimized new DSD and a non-optimized DSD in accordance with some aspects of the disclosure.

FIG. 3 is a schematic block diagram illustrating an exemplary monitoring of a source DSD within a storage device pool in accordance with some aspects of the disclosure.

FIG. 4 is a schematic block diagram illustrating an exemplary usage of data classification information when copying data from a source DSD to a new DSD in accordance with some aspects of the disclosure.

FIG. 5 is a schematic block diagram illustrating an exemplary usage of logical block addressing (LBA) information for outlier data when copying data from a source DSD to a new DSD in accordance with some aspects of the disclosure.

FIG. 6 is a schematic block diagram illustrating an exemplary storage management device configured to facilitate a configuration of new DSDs in a storage device pool in accordance with some aspects of the disclosure.

FIG. 7 is a flowchart illustrating a method/process for configuring new DSDs in a storage device pool that may be performed by a storage management device in accordance with some aspects of the disclosure.

FIG. 8 is a schematic block diagram illustrating an exemplary storage management device configured to facilitate a configuration of new DSDs in a storage device pool in accordance with some aspects of the disclosure.

FIG. 9 is a schematic block diagram configuration for an exemplary storage management device configured to facilitate a configuration of new DSDs in a storage device pool in accordance with some aspects of the disclosure.

FIG. 10 is a schematic block diagram illustrating an exemplary DSD embodied as a solid-state device (SSD) including an SSD controller configured to optimize a configuration of the SSD in accordance with some aspects of the disclosure.

FIG. 11 is a flowchart illustrating a method/process for optimizing a configuration of a DSD that may be performed by a controller of a DSD in accordance with some aspects of the disclosure.

FIG. 12 is a schematic block diagram illustrating an exemplary DSD configured to optimize a configuration of the DSD in accordance with some aspects of the disclosure.

FIG. 13 is a schematic block diagram configuration for an exemplary DSD configured to optimize a configuration of the DSD in accordance with some aspects of the disclosure.

### DETAILED DESCRIPTION

In the following detailed description, reference is made to the accompanying drawings, which form a part thereof. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

The examples herein relate to data storage devices (DSDs) and to storage management devices coupled to DSDs. In the main examples described herein, data is stored within non-volatile memory (NVM) arrays. In other examples, data may be stored in hard disk drives (HDD) using magnetic recording. DSDs with NVM arrays may be referred to as solid state devices (SSDs). Some SSDs use NAND flash memory, herein referred to as “NANDs.” A NAND is a type of non-volatile storage technology that does not require power to retain data. It exploits negative-AND, i.e., NAND, logic. For the sake of brevity, an SSD having one or more NAND dies will be used as a non-limiting example of a DSD below in the description of various embodiments. It is understood that at least some aspects described herein may be applicable to other forms of DSDs as well. For example, at least some aspects described herein may be applicable to phase-change memory (PCM) arrays, magneto-resistive random access memory (MRAM) arrays, and resistive random access memory (ReRAM) arrays.

### Overview

As indicated above, when a new SSD is added to a virtual storage pool (VSP), the firmware of the new SSD generally has the factory/manufacturer default settings which may not be optimal for the storage pool (i.e., because the firmware of the new SSD does not have advanced information about the data patterns and/or general environment of the VSP). Over time, however, the new SSD may learn VSP-specific characteristics, which can optimize the overall performance of the SSD (e.g., via hot/cold data classification). During this learning phase, the new SSD thus functions in a non-optimal manner. Aspects of the disclosure relate to techniques to effectively avoid the learning phase and non-optimal operation.

Aspects of the disclosure relate to improved techniques for the addition of new DSDs to a storage device pool. In a particular aspect disclosed herein, a storage management device (e.g., a server) configures new DSDs in accordance with properties learned by existing DSDs of the storage device pool (i.e., “source” DSDs). As a result, new DSDs may be optimized according to these properties immediately upon joining a storage device pool, rather than having to deduce such learnings over time. For example, a new DSD may be optimized to include settings (e.g., such as flash translation layer (FTL) settings) learned by the source DSD over time while it is a part of the storage device pool. These settings can include the ratio of single-level cell blocks versus multi-level cell blocks, defragmentation thresholds, settings for internal random access memory (RAM) sharing, or other configurable FTL settings. Where the new DSD is replacing a source DSD, the new DSD may be further optimized to include properties relating to the data being copied from the source DSD to the new DSD (e.g., classification of such data as hot/cold).

Several advantages are provided by these improved techniques for adding new DSDs to a storage device pool. For example, these improved techniques can reduce or eliminate the (initial) period of time during which the new DSD is in a state that is not optimized for the loads expected while in the storage pool. This can reduce the amount of internal data movement in the new DSD, which can help increase the throughput and life span of the DSD. The improved techniques disclosed herein also enable better caching schemes for outliers and frequently accessed logical block addresses (LBAs).

### Exemplary Devices, Systems and Procedures

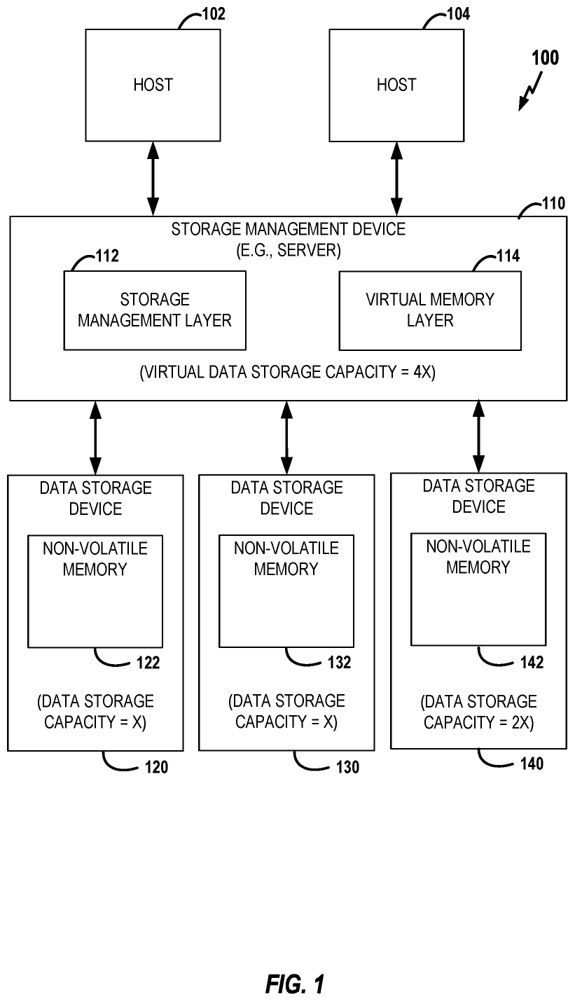

FIG. 1 is a schematic block diagram illustrating an exemplary data storage system including a storage management device configured to optimize new DSDs added to a storage device pool based on optimizations learned by existing DSDs in accordance with some aspects of the disclosure. As illustrated, data storage system 100 includes a storage management device 110 coupled to a plurality of DSDs 120, 130, and 140. The storage management device 110 can comprise a server, or other such device. The storage management device 110 may include a storage management layer 112 configured to manage a virtual storage pool (VSP) that includes DSDs 120, 130, and 140. The storage management device 110 may also include a virtual memory layer 114 configured to provide hosts 102 and 104 with an abstraction of DSDs 120, 130, and 140 embodied as a VSP, wherein the capacity of the VSP (i.e., “4X”) is the sum of the respective capacities of DSDs 120, 130, and 140 (i.e., “X”, “X”, and “2X”). Here, it should be appreciated that although FIG. 1 shows specific exemplary capacities for DSDs 120, 130, and 140, other suitable/relative capacities can be used in other embodiments.

As illustrated, the storage management device 110 is coupled to hosts 102 and 104. The hosts 102 and 104 provide commands and data to the storage management device 110 for storage in the VSP that includes DSDs 120, 130, and 140. For example, the hosts 102 and 104 may provide a write command to the storage management device 110 for writing data to the VSP, or a read command to the storage management device 110 for reading data from the VSP. The hosts 102 and 104 may be any system or device having a need for data storage or retrieval and a compatible interface for communicating with the VSP. For example, the hosts 102 and 104 may be a computing device, a personal computer, a portable computer, a workstation, a server, a personal digital assistant, a digital camera, or a digital phone as merely a few examples.

The DSDs 120, 130, and 140 can comprise one or more SSDs, and one or more other storage devices such as magnetic storage devices, tape drives, and the like. As illustrated, DSDs 120, 130, and 140 can each respectively include non-volatile memory (NVM) 122, 132, and 142 configured to store data.

In a particular embodiment, the storage management device 110 is configured to receive optimization information from at least one of DSDs 120, 130, and 140, wherein the optimization information includes at least one optimization learned by the at least one of DSDs 120, 130, and 140 while part of the data storage system 100; and configure a new data storage device (not shown) for the data storage system 100 with the at least one device optimization.

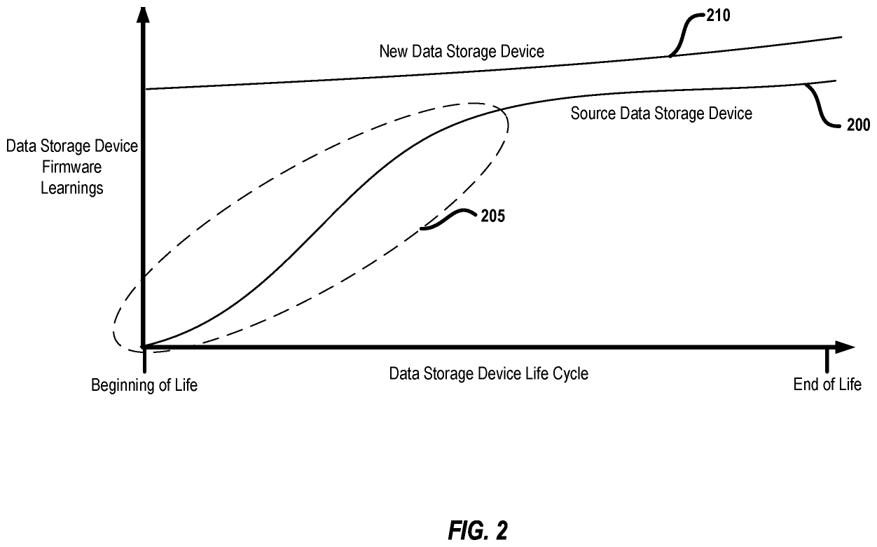

FIG. 2 is a graph comparing an optimized new DSD 210 and a non-optimized DSD 200 in accordance with some aspects of the disclosure. For this particular example, it is assumed that a source DSD 200 (initially not optimized) is part of a storage device pool, wherein the firmware of the source DSD 200 has no learned settings based on data loads it will experience while part of the storage device pool, at least at the beginning of the source DSD's life cycle 200. As illustrated, however, as data gets written to the source DSD, the firmware of the source DSD begins to learn various properties about the type of data, and frequency of access commands (e.g., write commands) as it operates within the storage device pool and tries to adapt settings accordingly. During a first portion 205 of the source DSD's life cycle 200, the source DSD may thus perform internal data movements inefficiently since its firmware does not yet know of the optimizations that it will learn over time. When a new DSD is added to the storage device pool, however, it is contemplated that the learnings (e.g., learned settings such as FTL settings) of the source DSD can be passed onto the new DSD. As illustrated, the life cycle of the new DSD 210 may thus begin with such optimizations known to be efficient for DSD operations in the storage device pool, rather than having to learn them over time.

### Algorithm and Resource Sharing Learnings

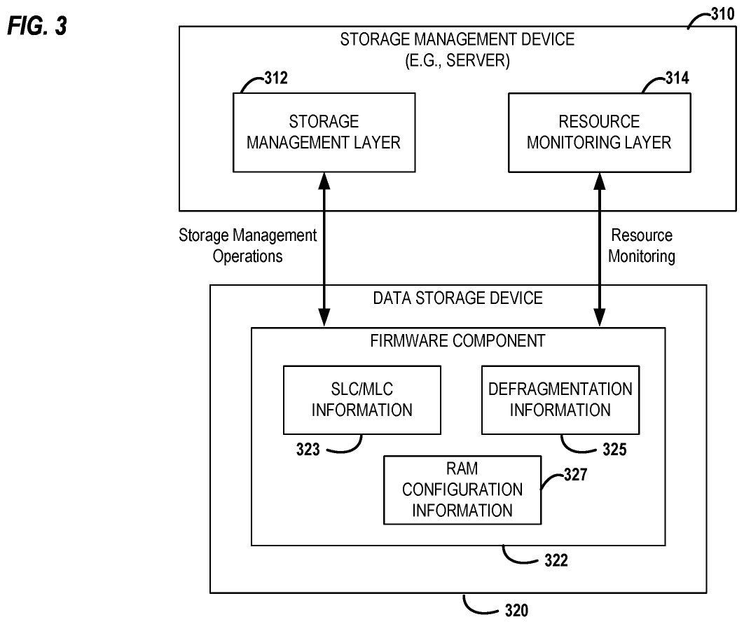

FIG. 3 is a schematic block diagram illustrating an exemplary monitoring of a source DSD within a storage device pool in accordance with some aspects of the disclosure. As illustrated, it is contemplated that a storage management device 310 is coupled to a DSD 320, wherein a storage management layer 312 of the storage management device 310 is configured to communicate with the firmware 322 of the DSD 320 to perform various storage management operations. It is further contemplated that the storage management device 310 may include a resource monitoring layer 314 configured to monitor various preferred settings the DSD 320 may learn over time. By monitor here, it is meant that the storage management device 310 may send a request to the DSD for the desired information and the DSD 320 may respond with the requested information. These requests may be sent periodically or aperiodically.

For instance, in a particular aspect, the resource monitoring layer 314 may be configured to monitor information 323 about how firmware 322 (e.g., firmware for controlling a flash translation layer (FTL) of the DSD) allocates blocks as single-level cell (SLC) blocks and multi-level cell (MLC) blocks. Such SLC/MLC information 323 may, for example, include a ratio of SLC blocks to MLC blocks configured by firmware 322 for the NVM in the DSD and how that ratio has performed over the life cycle of DSD 320. The storage management device 310 may then be further configured to analyze this SLC/MLC information 323 to determine an optimal SLC/MLC configuration for a new DSD to the storage device pool. In one aspect, the firmware 322 provides a preferred ratio and storage management device 310 may use that ratio to configure a new DSD.

In another aspect disclosed herein, the resource monitoring layer 314 may be configured to monitor defragmentation information 325 about DSD 320. Namely, the resource monitoring layer 314 may be configured to monitor various defragmentation properties of DSD 320 including, for example, the type of workload that triggered defragmentation of the DSD 320 over time. The storage management device 310 may then be further configured to analyze defragmentation information 325 to determine an optimal defragmentation threshold for a new DSD to the storage device pool. In one aspect, the DSD 320 can identify a preferred defragmentation threshold (in the defragmentation information) and the storage management device 310 may use that threshold to configure a new DSD. As used herein, defragmentation refers to a garbage collection process used on a DSD with flash memory to move valid data to new blocks and thereby free up old blocks for erasure and new data. The defragmentation threshold may be based on the number of free blocks available in the DSD or other similar thresholds as are known in the art.

In yet another aspect disclosed herein, it is noted that various hardware resources of DSD 320, such as RAM, are shared (e.g., in discrete caches) among multiple flows such as host reads, host writes, internal relocation operations, and logical-to-physical (L2P) tables. Accordingly, it is contemplated that resource monitoring layer 314 may be configured to monitor such internal RAM configuration information 327 about DSD 320, which can then be used by storage management device 310 to optimize a new DSD to the storage device pool. In one aspect, the DSD 320 can identify a preferred cache allocation between caches for host reads, host writes, internal relocation operations (e.g., defragmentation or garbage collection operations), and an L2P table, and the storage management device 310 may use that preferred cache allocation to configure a new DSD.

### Data Copying Learnings

Various optimizations related to the copying of data from a source DSD to a new DSD are also contemplated. For instance, when a new DSD replaces an older DSD in a storage device pool, it is contemplated that all valid data from source DSD may be copied to the new DSD in a manner that leverages data properties learned by the source SSD over time. Such properties related to the data being copied may be used, for example, to determine where to store such data in the new DSD (e.g., in SLC or MLC) and/or to select any of various caching schemes.

In a particular aspect disclosed herein, when copying data from a source DSD to a new DSD, it is contemplated that the source DSD's internal classification of hot/cold data can be leveraged to select an optimal location to store such data in the new DSD.

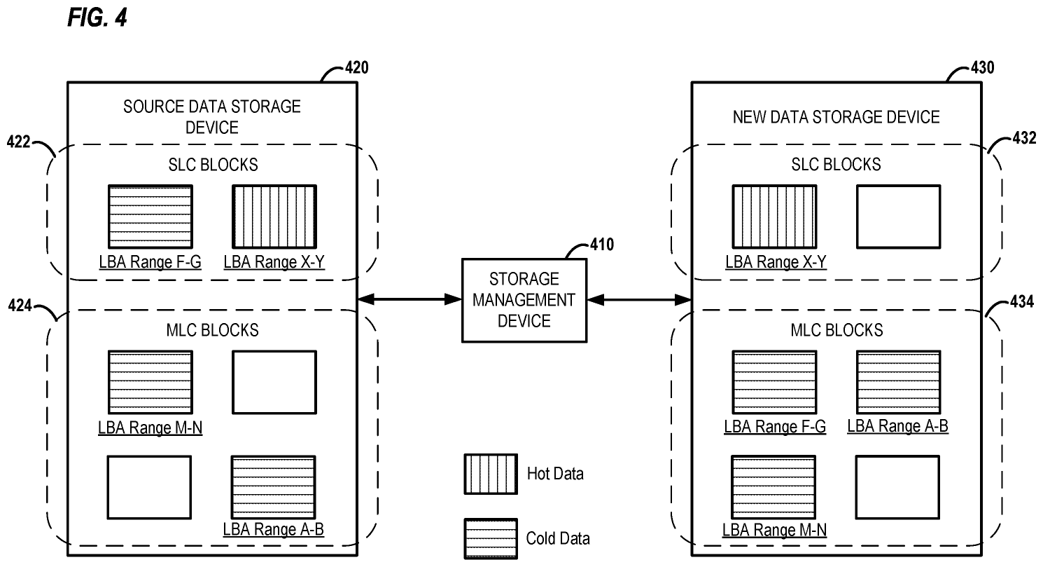

FIG. 4 is a schematic block diagram illustrating an exemplary usage of data classification information when copying data from a source DSD to a new DSD in accordance with some aspects of the disclosure. As illustrated, a storage management device 410 is configured to facilitate a copying of data from a source DSD 420, including SLC blocks 422 and MLC blocks 424, to a new DSD 430, including SLC blocks 432 and MLC blocks 434. For this particular example, data in source DSD 420 corresponding to various LBA ranges are classified as either “hot” data or “cold” data. Namely, data corresponding to LBA range X-Y is classified as hot, whereas data corresponding to LBA ranges F-G, M-N, and A-B is classified as cold. It is contemplated that storage management device 410 may leverage such classifications when copying data from source DSD 420 to new DSD 430. For instance, storage management device 410 may be configured to copy data classified as hot to SLC blocks 432 of new DSD 430, whereas data classified as cold may be copied to MLC blocks 434 of new DSD 430. Indeed, for this particular example, the hot data corresponding to LBA range X-Y is stored in SLC blocks 432, whereas the cold data corresponding to LBA ranges F-G, M-N, and A-B are stored in MLC blocks 434, as shown. It should be noted that, by leveraging such hot/cold classification from source DSD 420, the number of internal data movements in new DSD 430 are desirably reduced.

In another aspect disclosed herein, when copying data from a source DSD to a new DSD, it is further contemplated that a storage management device may leverage the source DSD's classifications for LBA ranges associated with portions of the copied data.

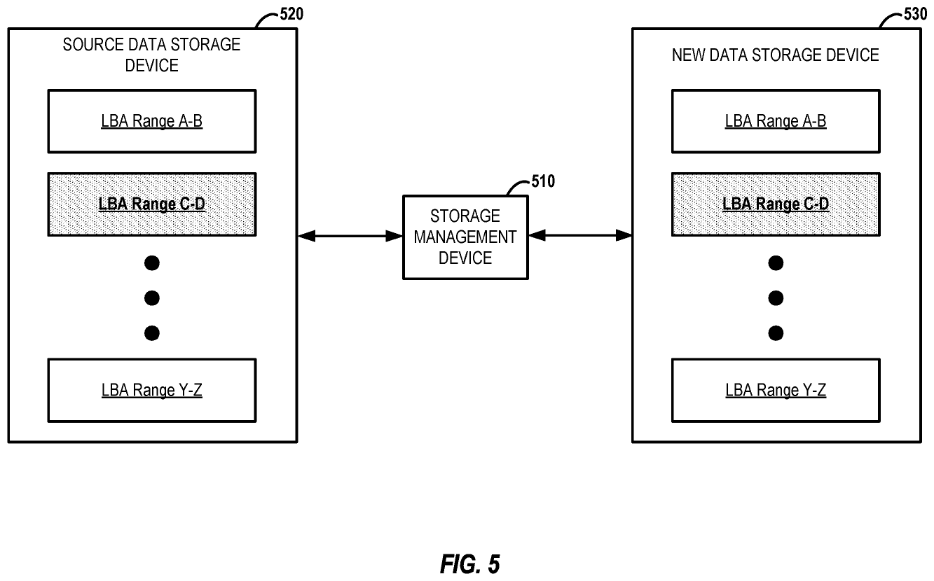

FIG. 5 is a schematic block diagram illustrating an exemplary usage of LBA information for outlier data when copying data from a source DSD to a new DSD in accordance with some aspects of the disclosure. As illustrated, a storage management device 510 is configured to facilitate a copying of data from a source DSD 520, comprising data stored in various LBA ranges, to a new DSD 530. Within such embodiment, it is contemplated that storage management device 510 may be configured to copy data from source DSD 520 to new DSD 530 based on the LBA range classifications used by source DSD 520. For instance, storage management device 510 may be configured to monitor LBA ranges in source DSD 520 to detect “outlier” LBA ranges, wherein an outlier LBA range is broadly defined as an LBA range having attributes that are uncharacteristic relative to other LBA ranges (e.g., LBA ranges in which data is written to frequently/infrequently; LBA ranges in which data is written to randomly/sequentially; LBA ranges in which data is quickly invalidated; etc.). Depending on whether a particular LBA range is classified as an outlier in source DSD 520, storage management device 510 may then configure new DSD 530 to store data in that LBA range in an appropriate physical block and with an appropriate L2P table caching scheme. For example, the LBA Range C-D in source DSD 520 may refer to a set of data that the source DSD 520 has determined to be an outlier because it is randomly written to and frequently. As such, the new DSD 530 can either be instructed or decide on its own to put this data (for LBA Range C-D) in SLC, effectively treating it as hot data.

It should be noted that deciding whether to store data in SLC or MLC is one of several optimizations new DSD 530 may implement. For instance, in a particular aspect, new DSD 530 may also fine tune L2P table caching policies. In DSDs having limited L2P table RAM, for example, L2P evictions (e.g., from the RAM to the NVM/NAND) may occur, wherein such evictions typically utilize a predetermined algorithm (e.g., a first-in-first-out (FIFO) algorithm). Such algorithms, however, may not be most efficient. In a particular aspect, it is thus contemplated that new DSD 530 may receive outlier information about LBA ranges learned by source DSD 520 so that evictions may be performed more efficiently. For instance, new DSD 530 may keep L2P table entries always cached for a first LBA range that is accessed frequently, and never cached for a different LBA range that is not accessed frequently.

In another aspect disclosed herein, LBA range information learned by source DSD 520 may also influence how new DSD 530 arranges LBAs in a NAND block. For instance, it may be desirable for new DSD 530 to group LBA ranges in a block having a similar life span (i.e., to avoid fragmentation when the LBAs get invalidated). The target block type thus can be SLC or MLC, depending on the LBA range information learned by source DSD 520.

### Exemplary Storage Management Device Embodiments

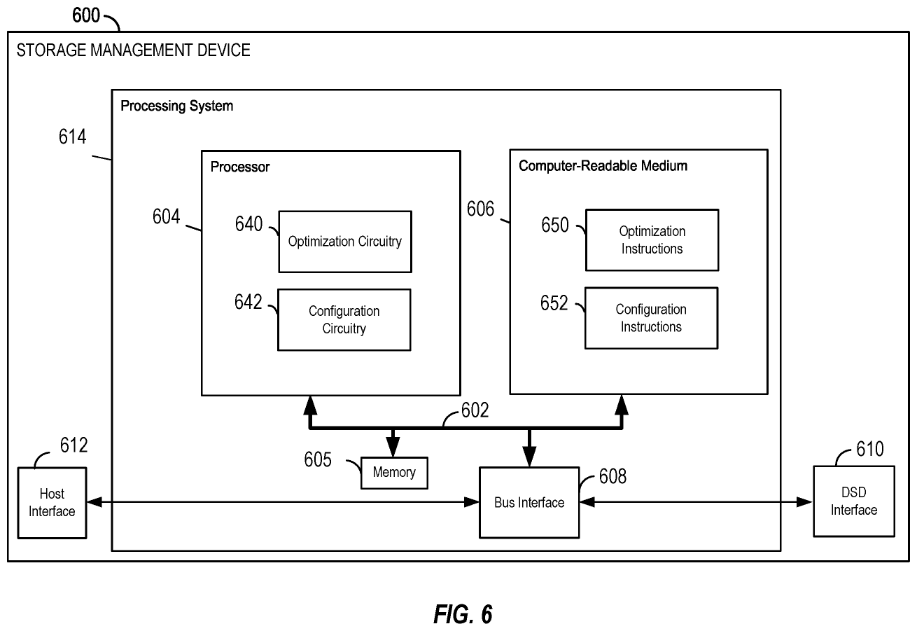

FIG. 6 is a schematic block diagram illustrating an exemplary storage management device 600 configured to facilitate a configuration of new DSDs in a storage device pool in accordance with some aspects of the disclosure. For example, the storage management device 600 may be a server as illustrated in any one or more of the FIGS. disclosed herein.

The storage management device 600 may be implemented with a processing system 614 that includes one or more processors 604. Examples of processors 604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the storage management device 600 may be configured to perform any one or more of the functions described herein. That is, the processor 604, as utilized in a storage management device 600, may be used to implement any one or more of the processes and procedures described below and illustrated in the FIGS. disclosed herein.

In this example, the processing system 614 may be implemented with a bus architecture, represented generally by the bus 602. The bus 602 may include any number of interconnecting buses and bridges depending on the specific application of the processing system 614 and the overall design constraints. The bus 602 communicatively couples together various circuits including one or more processors (represented generally by the processor 604), a memory 605, and computer-readable media (represented generally by the computer-readable medium 606). The bus 602 may also link various other circuits such as timing sources, peripherals, voltage regulators, and power management circuits, which are well known in the art, and therefore, will not be described any further. A bus interface 608 provides an interface between the bus 602 and a DSD interface 610 (e.g., a network interface). The DSD interface 610 provides a communication interface or means for communicating over a transmission medium with various other DSDs (e.g., any of DSDs 120, 130, and/or 140 illustrated in FIG. 1). Similarly, bus interface 608 provides an interface between the bus 602 and a host interface 612, wherein host interface 612 provides a communication interface or means for communicating over a transmission medium with various other hosts (e.g., any of hosts 102 and/or 104 illustrated in FIG. 1).

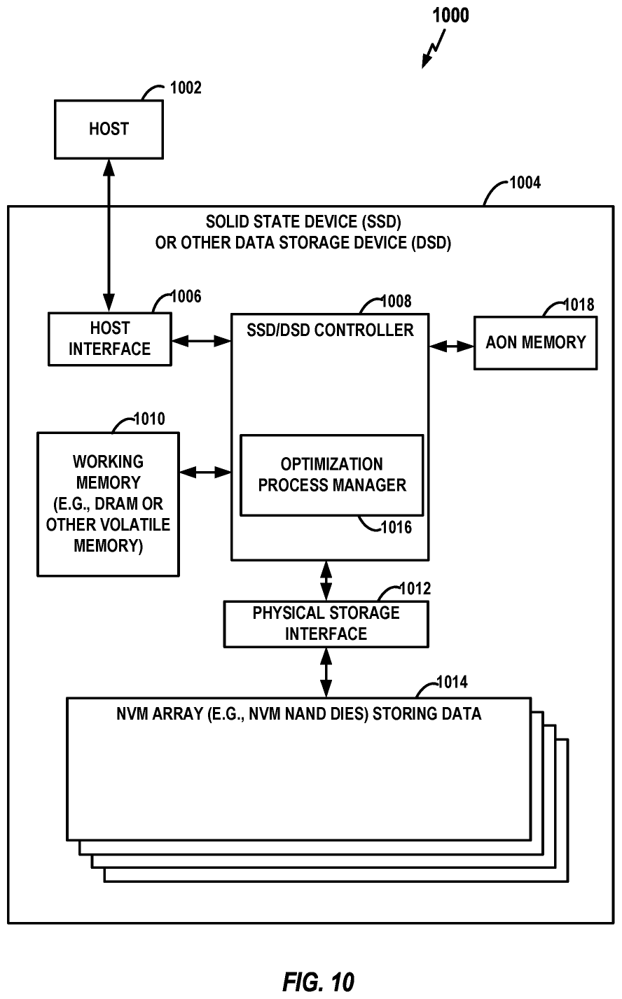

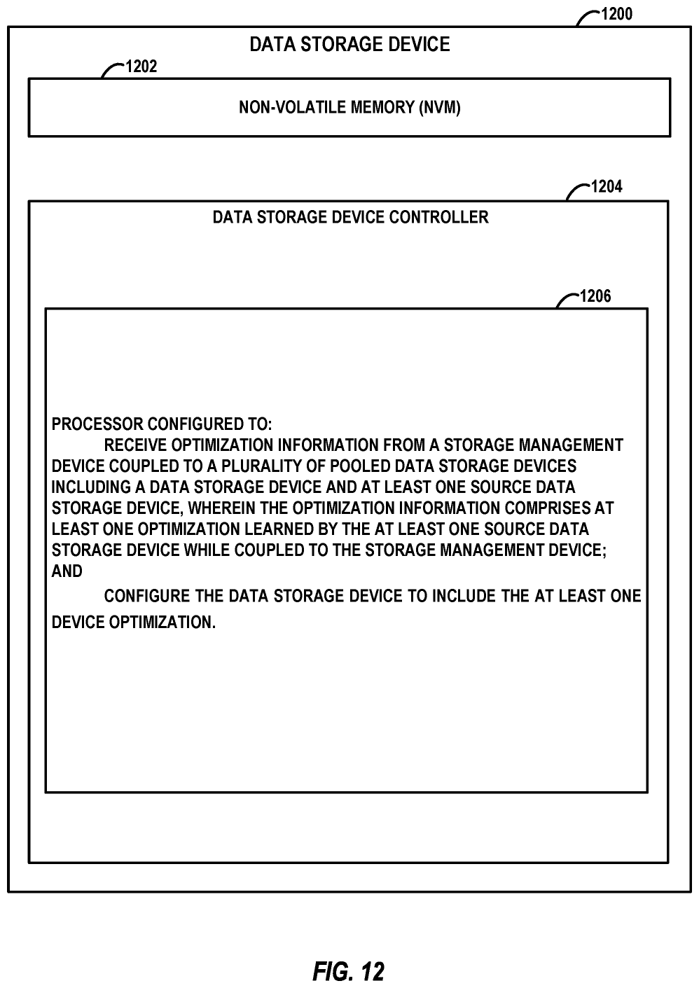

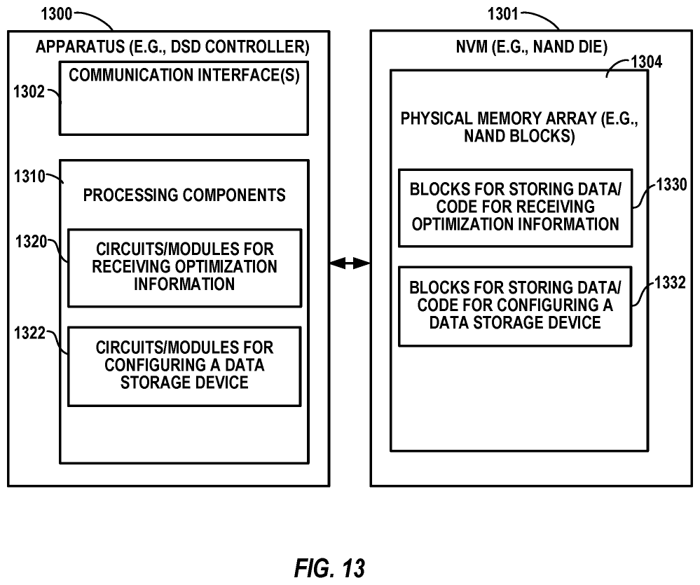

In some aspects of the disclosure, the processor 604 may include optimization circuitry 640 configured for various functions, including, for example, to receive optimization information from at least one source DSD (e.g., any of DSDs 120, 130, and/or 140 illustrated in FIG. 1; DSD 320 illustrated in FIG. 3; DSD 420 illustrated in FIG. 4; or DSD 520 illustrated in FIG. 5) of a plurality of DSDs, wherein the optimization information includes at least one optimization learned by the at least one source DSD while part of a data storage system. The processor 604 may further include configuration circuitry 642 configured for various functions, including, for example, to configure a new DSD (e.g., DSD 430 illustrated in FIG. 4; DSD 530 illustrated in FIG. 5; DSD 1004 illustrated in FIG. 10; DSD 1200 illustrated in FIG. 12; or the combination of apparatus 1300 and NVM 1301 illustrated in FIG. 13) for the data storage system with the at least one device optimization. It should also be appreciated that, the combination of the optimization circuitry 640 and the configuration circuitry 642 may be configured to implement one or more of the functions described herein.

Various other aspects for storage management device 500 are also contemplated. For instance, some aspects are directed towards leveraging different types of algorithmic information from a source DSD that has a flash memory, wherein the at least one optimization includes an optimization for a setting in a flash translation layer of the source DSD. Within such embodiment, the at least one optimization may include SLC/MLC information (e.g., information indicative of an allocation of SLC blocks and/or MLC blocks in the source DSD) and/or defragmentation information associated with the source DSD (e.g., information that includes at least one threshold indicative of a level at which the at least one source DSD would initiate a defragmentation process). In another aspect, the at least one optimization includes internal RAM configuration information associated with an internal RAM of the source DSD. Within such embodiment, the internal RAM configuration information may include an allocation of the internal RAM for storing at least one of: L2P table information; defragmentation information; host read information; or host write information.

Aspects for copying data from a source DSD to a new DSD are also contemplated. For instance, the processor 504 may be configured to maintain configuration settings for coupling to a plurality of DSDs, and to modify the configuration settings to replace at least one of the plurality of DSDs with the new DSD (e.g., where the new DSD is replacing the source DSD from which optimization information is received). Within such embodiment, the at least one optimization may include a classification of data copied from the source DSD to the new DSD, wherein the processor 504 is further configured to configure the new DSD to store the data based on the classification, and wherein the classification includes an indication of hot data and cold data among the copied data. In a particular aspect, the classification of the copied data may include classifications for one or more LBA ranges associated with portions of the copied data, wherein the processor 504 is further configured to configure the new DSD to store the copied data based on the classifications of the one or more LBA ranges.

Aspects directed towards adding, rather than replacing, a DSD are also disclosed. For instance, processor 504 may be configured to receive optimization information from multiple source DSDs of a storage device pool (e.g., multiple ones of DSDs 120, 130, and 140 illustrated in FIG. 1). Within such embodiment, processor 504 may be configured to analyze the optimization information from these source DSDs and determine a common setting or parameter, for example. Also, since source DSDs could have different internal architectures, processor 504 may be configured to give more weight to optimization information obtained from source DSDs having a similar architecture to the new DSD.

Referring back to the remaining components of storage management device 600, it should be appreciated that the processor 604 is responsible for managing the bus 602 and general processing, including the execution of software stored on the computer-readable medium 606. The software, when executed by the processor 604, causes the processing system 614 to perform the various functions described below for any particular apparatus. The computer-readable medium 606 and the memory 605 may also be used for storing data that is manipulated by the processor 604 when executing software.

One or more processors 604 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 606. The computer-readable medium 606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a RAM, a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 606 may reside in the processing system 614, external to the processing system 614, or distributed across multiple entities including the processing system 614. The computer-readable medium 606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 606 may include optimization instructions 650 configured for various functions, including, for example, to receive optimization information from at least one source DSD (e.g., any of DSDs 120, 130, and/or 140 illustrated in FIG. 1; DSD 320 illustrated in FIG. 3; DSD 420 illustrated in FIG. 4; or DSD 520 illustrated in FIG. 5) of a plurality of DSDs, wherein the optimization information includes at least one optimization learned by the at least one source DSD while part of a data storage system. The computer-readable storage medium 606 may further include configuration instructions 652 configured for various functions, including, for example, to configure a new DSD (e.g., DSD 430 illustrated in FIG. 4; DSD 530 illustrated in FIG. 5; DSD 1004 illustrated in FIG. 10; DSD 1200 illustrated in FIG. 12; or the combination of apparatus 1300 and NVM 1301 illustrated in FIG. 13) for the data storage system with the at least one device optimization.

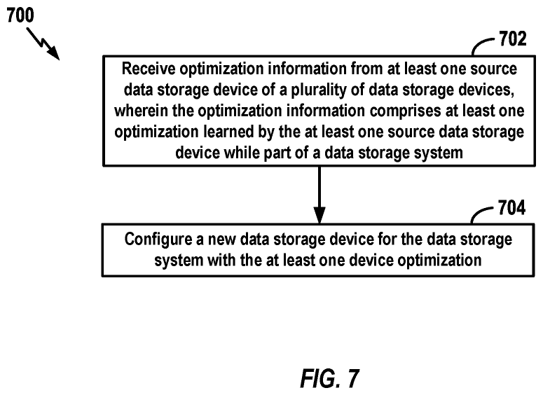

FIG. 7 is a flowchart illustrating a method/process 700 for configuring new DSDs in a storage device pool that may be performed by a storage management device in accordance with some aspects of the disclosure. In one aspect, the method/process 700 may be performed by processor 604. The DSDs described for process 700 can be any of DSDs 120, 130, and/or 140 illustrated in FIG. 1; DSD 320 illustrated in FIG. 3; any of DSDs 420 and/or 430 illustrated in FIG. 4; any of DSDs 520 and/or 530 illustrated in FIG. 5; DSD 1004 illustrated in FIG. 10; DSD 1200 illustrated in FIG. 12; or the combination of apparatus 1300 and NVM 1301 illustrated in FIG. 13.

At block 702, the method/process 700 receives optimization information from at least one source DSD (e.g., any of DSDs 120, 130, and/or 140 illustrated in FIG. 1; DSD 320 illustrated in FIG. 3; DSD 420 illustrated in FIG. 4; or DSD 520 illustrated in FIG. 5) of a plurality of DSDs, wherein the optimization information includes at least one optimization learned by the at least one source DSD while part of a data storage system, and wherein the at least one source DSD is one of a plurality of pooled DSDs of the data storage system. An example of such data storage system may be data storage system 100 illustrated in FIG. 1, which is embodied as a storage management device 110 coupled to a plurality of DSDs 120, 130, and 140. In a particular aspect, it should be noted that the pooled DSDs of a data storage system do not necessarily need to know that they are operating within a pool of DSDs. Accordingly, it should be further noted that the optimization information received at block 702 may simply relate to all optimizations learned by the at least one source DSD throughout its lifetime, wherein it is assumed that some/all of these optimizations are specific to the source DSD operating within a DSD pool of a data storage system.

The method/process 700 concludes at block 704 with the configuring of a new DSD (e.g., DSD 430 illustrated in FIG. 4; DSD 530 illustrated in FIG. 5; DSD 1004 illustrated in FIG. 10; DSD 1200 illustrated in FIG. 12; or the combination of apparatus 1300 and NVM 1301 illustrated in FIG. 13) for the data storage system with the at least one device optimization. For instance, it is contemplated that the configuring performed at block 704 may include having the storage management device send the new DSD a special command that includes the at least one device optimization. It is further contemplated that such special command may instruct the new DSD to set one or more of its operational parameters to be the same as the at least one device optimization from the storage management device. Upon receiving the special command, the new DSD may then set its operational parameters corresponding to the device optimization, to the value specified by the device optimization.

Various other aspects for method/process 700 are also contemplated. For instance, some aspects are directed towards leveraging different types of algorithmic information from a source DSD that has a flash memory, wherein the at least one optimization includes an optimization for a setting in a flash translation layer of the source DSD. Within such embodiment, the at least one optimization may include SLC/MLC information (e.g., information indicative of an allocation of SLC blocks and/or MLC blocks in the source DSD) and/or defragmentation information associated with the source DSD (e.g., information that includes at least one threshold indicative of a level at which the at least one source DSD would initiate a defragmentation process). In another aspect, the at least one optimization includes internal RAM configuration information associated with an internal RAM of the source DSD. Within such embodiment, the internal RAM configuration information may include an allocation of the internal RAM for storing at least one of: L2P table information; defragmentation information; host read information; or host write information.

Aspects for copying data from a source DSD to a new DSD are also contemplated. For instance, the method/process 600 may include additional blocks directed towards maintaining configuration settings for coupling to a plurality of DSDs, and modifying the configuration settings to replace at least one of the plurality of DSDs with the new DSD (e.g., where the new DSD is replacing the source DSD from which optimization information is received). Within such embodiment, the at least one optimization may include a classification of data copied from the source DSD to the new DSD, wherein the method/process 600 may then further include blocks directed towards configuring the new DSD to store the data based on the classification, and wherein the classification includes an indication of hot data and cold data among the copied data. In a particular aspect, the classification of the copied data may include classifications for one or more LBA ranges associated with portions of the copied data, wherein the method/process 600 may include additional blocks directed towards configuring the new DSD to store the copied data based on the classifications of the one or more LBA ranges.

Aspects directed towards adding, rather than replacing, a DSD are also disclosed. For instance, the method/process 600 may include additional blocks directed towards receiving optimization information from multiple source DSDs of a storage device pool (e.g., multiple ones of DSDs 120, 130, and 140 illustrated in FIG. 1). Within such embodiment, the method/process 600 may then further include blocks directed towards analyzing the optimization information from these source DSDs and determining a common setting or parameter (or an average of these across all of the source DSDs), for example. Also, since source DSDs could have different internal architectures, the method/process 600 may include blocks directed towards giving more weight to optimization information obtained from source DSDs having a similar architecture to the new DSD.

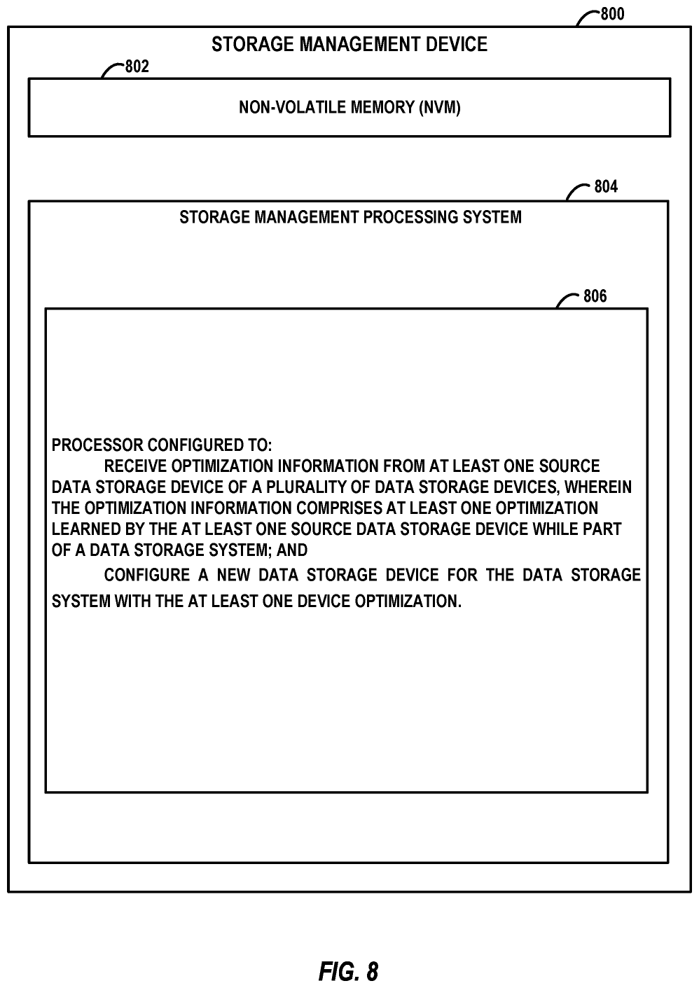

FIG. 8 is a schematic block diagram illustrating an exemplary storage management device 800 configured to facilitate a configuration of new DSDs in a storage device pool in accordance with some aspects of the disclosure. The storage management device 800 includes a non-volatile memory (NVM) 802 and a storage management processing system 804. The storage management processing system 804 includes a processor or processing circuit 806 configured to: receive optimization information from at least one source DSD (e.g., any of DSDs 120, 130, and/or 140 illustrated in FIG. 1; DSD 320 illustrated in FIG. 3; DSD 420 illustrated in FIG. 4; or DSD 520 illustrated in FIG. 5) of a plurality of DSDs, wherein the optimization information includes at least one optimization learned by the at least one source DSD while part of a data storage system; and configure a new DSD (e.g., DSD 430 illustrated in FIG. 4; DSD 530 illustrated in FIG. 5; DSD 1004 illustrated in FIG. 10; DSD 1200 illustrated in FIG. 12; or the combination of apparatus 1300 and NVM 1301 illustrated in FIG. 13) for the data storage system with the at least one device optimization.

Various other aspects for storage management device 800 are also contemplated. For instance, some aspects are directed towards leveraging different types of algorithmic information from a source DSD that has a flash memory, wherein the at least one optimization includes an optimization for a setting in a flash translation layer of the source DSD. Within such embodiment, the at least one optimization may include SLC/MLC information (e.g., information indicative of an allocation of SLC blocks and/or MLC blocks in the source DSD) and/or defragmentation information associated with the source DSD (e.g., information that includes at least one threshold indicative of a level at which the at least one source DSD would initiate a defragmentation process). In another aspect, the at least one optimization includes internal RAM configuration information associated with an internal RAM of the source DSD. Within such embodiment, the internal RAM configuration information may include an allocation of the internal RAM for storing at least one of: L2P table information; defragmentation information; host read information; or host write information.

The processor 806 may also be configured to facilitate copying data from a source DSD to a new DSD. For instance, the processor 806 may be configured to maintain configuration settings for coupling to a plurality of DSDs, and to modify the configuration settings to replace at least one of the plurality of DSDs with the new DSD (e.g., where the new DSD is replacing the source DSD from which optimization information is received). Within such embodiment, the at least one optimization may include a classification of data copied from the source DSD to the new DSD, wherein the processor 806 is further configured to configure the new DSD to store the data based on the classification, and wherein the classification includes an indication of hot data and cold data among the copied data. In a particular aspect, the classification of the copied data may include classifications for one or more LBA ranges associated with portions of the copied data, wherein the processor 806 is further configured to configure the new DSD to store the copied data based on the classifications of the one or more LBA ranges.

Aspects directed towards adding, rather than replacing, a DSD are also disclosed. For instance, processor 706 may be configured to receive optimization information from multiple source DSDs of a storage device pool (e.g., multiple ones of DSDs 120, 130, and 140 illustrated in FIG. 1). Within such embodiment, processor 706 may be configured to analyze the optimization information from these source DSDs and determine a common setting or parameter (or an average of these across all of the source DSDs), for example. Also, since source DSDs could have different internal architectures, processor 706 may be configured to give more weight to optimization information obtained from source DSDs having a similar architecture to the new DSD.

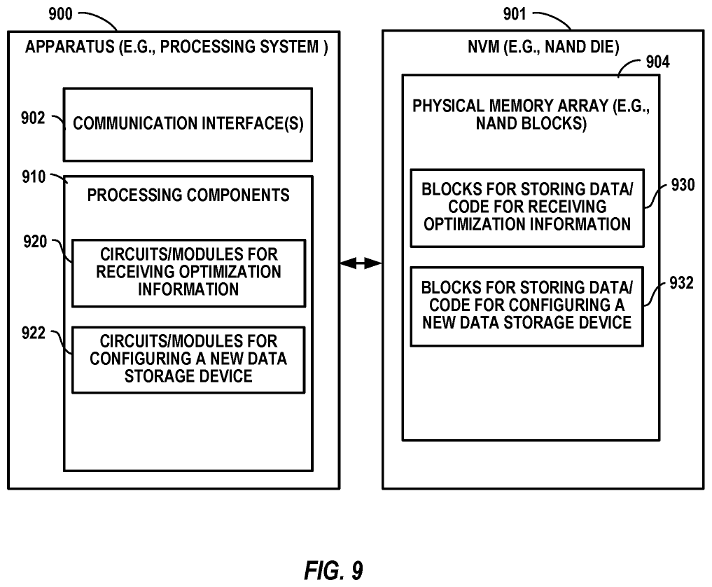

FIG. 9 is a schematic block diagram configuration for an exemplary storage management device 900 configured to facilitate a configuration of new DSDs in a storage device pool in accordance with some aspects of the disclosure. The apparatus 900, or components thereof, could embody or be implemented within a processing system (e.g., processing system 614 illustrated in FIG. 6) such as a processing system coupled to a volatile memory (not shown) and a NAND die or some other type of NVM array that supports data storage. In various implementations, the apparatus 900, or components thereof, could be a component of a processor, a controller, a computing device, a personal computer, a portable device, workstation, a server, a personal digital assistant, a digital camera, a digital phone, an entertainment device, a medical device, a self-driving vehicle control device, an edge device, or any other electronic device that stores, processes, or uses data.

The apparatus 900 includes a communication interface 902 and is coupled to a NVM 901 (e.g., a NAND die). The NVM 901 includes physical memory array 904. These components can be coupled to and/or placed in electrical communication with one another via suitable components, represented generally by the connection line in FIG. 9. Although not shown, other circuits such as timing sources, peripherals, voltage regulators, and power management circuits may be provided, which will not be described any further. Additional components, such as those shown in FIG. 6, may also be included with apparatus 900.

The communication interface 902 of the apparatus 900 provides a means for communicating with other apparatuses over a transmission medium. In some implementations, the communication interface 902 includes circuitry and/or programming (e.g., a program) adapted to facilitate the communication of information bi-directionally with respect to one or more devices in a system. In some implementations, the communication interface 902 may be configured for wire-based communication. For example, the communication interface 902 could be a bus interface, a send/receive interface, or some other type of signal interface including circuitry for outputting and/or obtaining signals (e.g., outputting signal from and/or receiving signals into a storage management device).

The physical memory array 904 may include one or more NAND blocks 940, or other suitable NVM blocks. The physical memory array 904 may be accessed by the processing components 910.

In one aspect, the apparatus 900 may also include volatile memory for storing instructions and other information to support the operation of the processing components 910.

The apparatus 900 includes various processing components 910 arranged or configured to obtain, process and/or send data, control data access and storage, issue or respond to commands, and control other desired operations. For example, the components 910 may be implemented as one or more processors, one or more controllers, and/or other structures configured to perform functions. According to one or more aspects of the disclosure, the components 910 may be adapted to perform any or all of the features, processes, functions, operations and/or routines described herein. For example, the components 910 may be configured to perform any of the steps, functions, and/or processes described with respect to the FIGS. included herein. As used herein, the term “adapted” in relation to components 910 may refer to the components being one or more of configured, employed, implemented, and/or programmed to perform a particular process, function, operation and/or routine according to various features described herein. The circuits may include a specialized processor, such as an ASIC that serves as a means for (e.g., structure for) carrying out any one of the operations described, e.g., in conjunction with the FIGS. included herein. The components 910 serve as an example of a means for processing. In various implementations, the components 910 may provide and/or incorporate, at least in part, functionality described above for the components of processing system 614 of FIG. 6 or storage management processing system 804 of FIG. 8.

According to at least one example of the apparatus 900, the processing components 910 may include one or more of: circuit/modules 920 configured for receiving optimization information; and circuits/modules 922 configured for configuring a new DSD.

The physical memory array 904 may include one or more of: blocks 930 configured to store data/code for receiving optimization information; and blocks 932 configured to store data/code for configuring a new DSD.

In at least some examples, means may be provided for performing the functions illustrated in FIG. 8 and/or other functions illustrated or described herein. For example, the means may include one or more of: means, such as circuit/module 920, for receiving optimization information from at least one source DSD (e.g., any of DSDs 120, 130, and/or 140 illustrated in FIG. 1; DSD 320 illustrated in FIG. 3; DSD 420 illustrated in FIG. 4; or DSD 520 illustrated in FIG. 5) of a plurality of DSDs, wherein the optimization information includes at least one optimization learned by the at least one source DSD while part of a data storage system; and means, such as circuit/module 922 for configuring a new DSD (e.g., DSD 430 illustrated in FIG. 4; DSD 530 illustrated in FIG. 5; DSD 1004 illustrated in FIG. 10; DSD 1200 illustrated in FIG. 12; or the combination of apparatus 1300 and NVM 1301 illustrated in FIG. 13) for the data storage system with the at least one device optimization.

In the examples of the FIGS. included herein, NAND memory is sometimes set forth as an exemplary NVM. In one aspect, the NVM may be flash memory or another suitable NVM, examples of which are noted above at the beginning of the Detailed Description section.

### Exemplary Data Storage Device Embodiments

FIG. 10 is a schematic block diagram illustrating an exemplary DSD embodied as an SSD, including an SSD controller configured to optimize a configuration of the SSD in accordance with some aspects of the disclosure. The system 1000 includes a host 1002 and the SSD 1004 (or other DSD, but for simplicity referred to as an SSD below) coupled to the host 1002. The host 1002 provides commands to the SSD 1004 for transferring data between the host 1002 and the SSD 1004. For example, the host 1002 may provide a write command to the SSD 1004 for writing data to the SSD 1004 or read command to the SSD 1004 for reading data from the SSD 1004. The host 1002 may be any system or device having a need for data storage or retrieval and a compatible interface for communicating with the SSD 1004. For example, the host 1002 may be a computing device, a personal computer, a portable computer, a workstation, a server, a personal digital assistant, a digital camera, or a digital phone as merely a few examples.

The SSD 1004 includes a host interface 1006, an SSD or DSD controller 1008, a working memory 1010 (such as dynamic random access memory (DRAM) or other volatile memory), a physical storage (PS) interface 1012 (e.g., flash interface module (FIM)), and an NVM array 1014 having one or more dies storing data. The host interface 1006 is coupled to the controller 1008 and facilitates communication between the host 1002 and the controller 1008. The controller 1008 is coupled to the working memory 1010 as well as to the NVM array 1014 via the PS interface 1012. The host interface 1006 (like host interface 612 or DSD interface 610) may be any suitable communication interface, such as a Non-Volatile Memory express (NVMe) interface, a Universal Serial Bus (USB) interface, a Serial Peripheral (SP) interface, an Advanced Technology Attachment (ATA) or Serial Advanced Technology Attachment (SATA) interface, a Small Computer System Interface (SCSI), an Institute of Electrical and Electronics Engineers (IEEE) 1394 (Firewire) interface, Secure Digital (SD), or the like. In some embodiments, the host 1002 includes the SSD 1004. In other embodiments, the SSD 1004 is remote from the host 1002 or is contained in a remote computing system communicatively coupled with the host 1002. For example, the host 1002 may communicate with the SSD 1004 through a wireless communication link. The NVM array 1014 may include multiple dies.

In some examples, the host 1002 may be a laptop computer with an internal SSD and a user of the laptop may wish to playback video stored by the SSD. In another example, the host again may be a laptop computer, but the video is stored by a remote server.

Although, in the example illustrated in FIG. 10, SSD 1004 includes a single channel between controller 1008 and NVM array 1014 via PS interface 1012, the subject matter described herein is not limited to having a single memory channel. For example, in some NAND memory system architectures, two, four, eight or more NAND channels couple the controller and the NAND memory device, depending on controller capabilities. In any of the embodiments described herein, more than a single channel may be used between the controller and the memory die, even if a single channel is shown in the drawings. The controller 1008 may be implemented in a single integrated circuit chip and may communicate with different layers of memory in the NVM 1014 over one or more command channels.

The controller 1008 controls operation of the SSD 1004. In various aspects, the controller 1008 receives commands from the host 1002 through the host interface 1006 and performs the commands to transfer data between the host 1002 and the NVM array 1014. Furthermore, the controller 1008 may manage reading from and writing to working memory 1010 for performing the various functions effected by the controller and to maintain and manage cached information stored in the working memory 1010.

The controller 1008 may include any type of processing device, such as a microprocessor, a microcontroller, an embedded controller, a logic circuit, software, firmware, or the like, for controlling operation of the SSD 1004. In some aspects, some or all of the functions described herein as being performed by the controller 1008 may instead be performed by another element of the SSD 1004. For example, the SSD 1004 may include a microprocessor, a microcontroller, an embedded controller, a logic circuit, software, firmware, application specific integrated circuit (ASIC), or any kind of processing device, for performing one or more of the functions described herein as being performed by the controller 1008. According to other aspects, one or more of the functions described herein as being performed by the controller 1008 are instead performed by the host 1002. In still further aspects, some or all of the functions described herein as being performed by the controller 1008 may instead be performed by another element such as a controller in a hybrid drive including both non-volatile memory elements and magnetic storage elements. In one aspect, the controller 1008 can store SSD status information in an always ON (AON) memory 1018 or other suitable memory such as the NVM array 1014.

The SSD controller 1008 includes an optimization process manager 1016, which can be configured to perform optimization process management as will be described in further detail below. In one aspect, the optimization process manager 1016 is a module within the SSD controller 1008 that is controlled by firmware. In one aspect, the optimization process manager 1016 may be a separate component from the SSD controller 1008 and may be implemented using any combination of hardware, software, and firmware (e.g., like the implementation options described above for SSD controller 1008) that can perform defragmentation process management as will be described in further detail below. In one example, the optimization process manager 1016 is implemented using a firmware algorithm or other set of instructions that can be performed on the SSD controller 1008 to implement the optimization process management functions described below.

The working memory 1010 may be any suitable memory, computing device, or system capable of storing data. For example, working memory 1010 may be ordinary RAM, DRAM, double data rate (DDR) RAM, static RAM (SRAM), synchronous dynamic RAM (SDRAM), a flash storage, an erasable programmable read-only-memory (EPROM), an electrically erasable programmable ROM (EEPROM), or the like. In various embodiments, the controller 1008 uses the working memory 1010, or a portion thereof, to store data during the transfer of data between the host 1002 and the NVM array 1014. For example, the working memory 1010 or a portion of the volatile memory 1010 may be used as a cache memory. The NVM array 1014 receives data from the controller 1008 via the PS interface 1012 and stores the data. In some embodiments, working memory 1010 may be replaced by a non-volatile memory such as MRAM, PCM, ReRAM, etc. to serve as a working memory for the overall device.

The NVM array 1014 may be implemented using flash memory (e.g., NAND flash memory). In one aspect, the NVM array 1014 may be implemented using any combination of NAND flash, PCM arrays, MRAM arrays, and/or ReRAM.

The PS interface 1012 provides an interface to the NVM array 1014. For example, in the case where the NVM array 1014 is implemented using NAND flash memory, the PS interface 1012 may be a flash interface module. In one aspect, the PS interface 1012 may be implemented as a component of the SSD controller 1008.

In the example of FIG. 10, the controller 1008 may include hardware, firmware, software, or any combinations thereof that provide the functionality for the optimization process manager 1016.

Although FIG. 10 shows an exemplary SSD and an SSD is generally used as an illustrative example in the description throughout, the various disclosed embodiments are not necessarily limited to an SSD application/implementation. As an example, the disclosed NVM array and associated processing components can be implemented as part of a package that includes other processing circuitry and/or components. For example, a processor may include, or otherwise be coupled with, embedded NVM array and associated circuitry. The processor could, as one example, off-load certain operations to the NVM and associated circuitry and/or components. As another example, the SSD controller 1008 may be a controller in another type of device and still be configured to perform/control optimization process management, and perform/control some or all of the other functions described herein.

The AON memory 1018 may be any suitable memory, computing device, or system capable of storing data with a connection to power that does not get switched off. For example, AON memory 1018 may be ordinary RAM, DRAM, double data rate (DDR) RAM, static RAM (SRAM), synchronous dynamic RAM (SDRAM), a flash storage, an erasable programmable read-only-memory (EPROM), an electrically erasable programmable ROM (EEPROM), or the like with a continuous power supply. In one aspect, the AON memory 1018 may be a RAM with a continuous power supply (e.g., a connection to power that cannot be switched off unless there is a total loss of power to the SSD, such as during a graceful or ungraceful shutdown). In some aspects, the AON memory 1018 is an optional component. Thus, in at least some aspects, the SSD 1004 does not include the AON memory 1018.

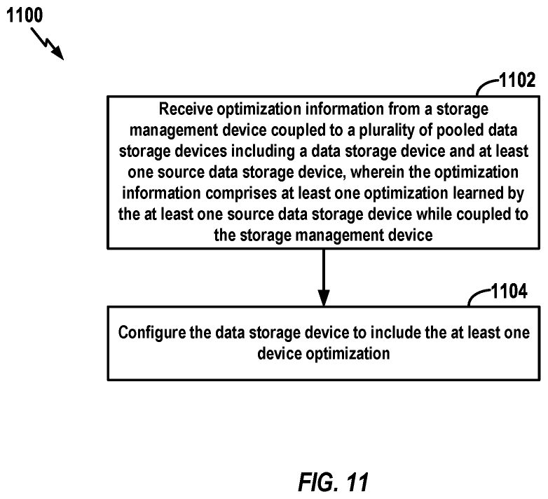

FIG. 11 is a flowchart illustrating a method/process 1100 for optimizing a configuration of a DSD that may be performed by a controller of a DSD in accordance with some aspects of the disclosure. In one aspect, the method/process 1100 may be performed by the SSD/DSD controller 1008 (or optimization process manager 1016) of FIG. 10, the DSD controller 1204 of FIG. 12, the DSD controller 1300 of FIG. 13, or any other suitably equipped device controller. An NVM to facilitate process 1100 can be the working NVM of the SSD such as NVM arrays 1014 of FIG. 10, NVM 1202 of FIG. 12, or NVM 1301 of FIG. 13.

At block 1102, the method/process 1100 receives optimization information from a storage management device (e.g., storage management device 110 illustrated in FIG. 1; storage management device 310 illustrated in FIG. 3; storage management device 410 illustrated in FIG. 4; storage management device 510 illustrated in FIG. 5; storage management device 600 illustrated in FIG. 6; storage management device 800 illustrated in FIG. 8; or the combination of apparatus 900 and NVM 901 illustrated in FIG. 9) coupled to a plurality of pooled DSDs including the DSD (e.g., new DSD 430 illustrated in FIG. 4; DSD 530 illustrated in FIG. 5; DSD 1004 illustrated in FIG. 10; DSD 1200 illustrated in FIG. 12; or the combination of apparatus 1300 and NVM 1301 illustrated in FIG. 13) and at least one source DSD (e.g., any combination of DSDs 120, 130, and/or 140 illustrated in FIG. 1), wherein the optimization information includes at least one optimization learned by the at least one source DSD while coupled to the storage management device. The method/process 1100 then concludes at block 1104 with the configuring of the DSD (e.g., DSD 430 illustrated in FIG. 4; DSD 530 illustrated in FIG. 5; DSD 1004 illustrated in FIG. 10; DSD 1200 illustrated in FIG. 12; or the combination of apparatus 1300 and NVM 1301 illustrated in FIG. 13) to include the at least one device optimization. For instance, it is contemplated that the configuring performed at block 1104 may include having the DSD receive a special command from the storage management device that includes the at least one device optimization. It is further contemplated that such special command may instruct the DSD to set one or more of its operational parameters to be the same as the at least one device optimization from the storage management device. Upon receiving the special command, the new DSD may thus set its operational parameters corresponding to the device optimization, to the value specified by the device optimization.

Various other aspects for method/process 1100 are also contemplated. For instance, it is contemplated that the at least one optimization may include any of various types of information. In a particular embodiment, the at least one optimization includes SLC/MLC information indicative of an allocation of SLC blocks and MLC blocks in the at least one source DSD. In another embodiment, the at least one optimization includes defragmentation information associated with the at least one source DSD, wherein the defragmentation information includes at least one threshold indicative of a level at which the at least one source DSD would initiate a defragmentation process. In yet another embodiment, the at least one optimization includes internal RAM configuration information associated with an internal RAM of the at least one source DSD.

Aspects for copying data from a source DSD to a new DSD are also contemplated. For instance, the at least one optimization may include a classification of data copied from the at least one source DSD to the new DSD, wherein the classification includes an indication of hot data and cold data among the copied data, and wherein an NVM of the new DSD includes SLC blocks and MLC blocks. Within such embodiment, the method/process 1100 may include additional blocks directed towards storing the hot data in the SLC blocks, and storing the cold data in the MLC blocks.

FIG. 12 is a schematic block diagram illustrating an exemplary DSD 1200 configured to optimize a configuration of the DSD in accordance with some aspects of the disclosure. The DSD 1200 includes an NVM 1202 and a DSD controller 1204. The DSD controller 1204 includes a processor or processing circuit 1206 configured to: receive optimization information from a storage management device (e.g., storage management device 110 illustrated in FIG. 1; storage management device 310 illustrated in FIG. 3; storage management device 410 illustrated in FIG. 4; storage management device 510 illustrated in FIG. 5; storage management device 600 illustrated in FIG. 6; storage management device 800 illustrated in FIG. 8; or the combination of apparatus 900 and NVM 901 illustrated in FIG. 9) coupled to a plurality of pooled DSDs including DSD 1200 and at least one source DSD (e.g., any combination of DSDs 120, 130, and/or 140 illustrated in FIG. 1), wherein the optimization information includes at least one optimization learned by the at least one source DSD while coupled to the storage management device; and configure the 1200 to include the at least one device optimization.

Various other aspects for DSD 1200 are also contemplated. For instance, it is contemplated that the at least one optimization may include any of various types of information. In a particular embodiment, the at least one optimization includes SLC/MLC information indicative of an allocation of SLC blocks and MLC blocks in the at least one source DSD. In another embodiment, the at least one optimization includes defragmentation information associated with the at least one source DSD, wherein the defragmentation information includes at least one threshold indicative of a level at which the at least one source DSD would initiate a defragmentation process. In yet another embodiment, the at least one optimization includes internal RAM configuration information associated with an internal RAM of the at least one source DSD.

Aspects for copying data from a source DSD to a new DSD are also contemplated. For instance, the at least one optimization may include a classification of data copied from the at least one source DSD to the new DSD, wherein the classification includes an indication of hot data and cold data among the copied data, and wherein an NVM of the new DSD includes SLC blocks and MLC blocks. Within such embodiment, the processor 1106 may be further configured to store the hot data in the SLC blocks, and store the cold data in the MLC blocks.

FIG. 13 is a schematic block diagram configuration for an exemplary DSD 1300 configured to optimize a configuration of the DSD in accordance with some aspects of the disclosure. The apparatus 1300, or components thereof, could embody or be implemented within a data storage controller such as a DSD controller coupled to a volatile memory (not shown) and a NAND die or some other type of NVM array that supports data storage. In various implementations, the apparatus 1300, or components thereof, could be a component of a processor, a controller, a computing device, a personal computer, a portable device, workstation, a server, a personal digital assistant, a digital camera, a digital phone, an entertainment device, a medical device, a self-driving vehicle control device, an edge device, or any other electronic device that stores, processes, or uses data.

The apparatus 1300 includes a communication interface 1302 and is coupled to a NVM 1301 (e.g., a NAND die). The NVM 1301 includes physical memory array 1304. These components can be coupled to and/or placed in electrical communication with one another via suitable components, represented generally by the connection line in FIG. 13. Although not shown, other circuits such as timing sources, peripherals, voltage regulators, and power management circuits may be provided, which will not be described any further. Additional components, such as those shown in FIG. 10, may also be included with apparatus 1000.

The communication interface 1302 of the apparatus 1300 provides a means for communicating with other apparatuses over a transmission medium. In some implementations, the communication interface 1302 includes circuitry and/or programming (e.g., a program) adapted to facilitate the communication of information bi-directionally with respect to one or more devices in a system. In some implementations, the communication interface 1302 may be configured for wire-based communication. For example, the communication interface 1302 could be a bus interface, a send/receive interface, or some other type of signal interface including circuitry for outputting and/or obtaining signals (e.g., outputting signal from and/or receiving signals into a DSD).

The physical memory array 1304 may include one or more NAND blocks 1340, or other suitable NVM blocks. The physical memory array 1304 may be accessed by the processing components 1310.

In one aspect, the apparatus 1300 may also include volatile memory for storing instructions and other information to support the operation of the processing components 1310.

The apparatus 1300 includes various processing components 1310 arranged or configured to obtain, process and/or send data, control data access and storage, issue or respond to commands, and control other desired operations. For example, the components 1310 may be implemented as one or more processors, one or more controllers, and/or other structures configured to perform functions. According to one or more aspects of the disclosure, the components 1310 may be adapted to perform any or all of the features, processes, functions, operations and/or routines described herein. For example, the components 1310 may be configured to perform any of the steps, functions, and/or processes described with respect to the FIGS. included herein. As used herein, the term “adapted” in relation to components 1310 may refer to the components being one or more of configured, employed, implemented, and/or programmed to perform a particular process, function, operation and/or routine according to various features described herein. The circuits may include a specialized processor, such as an ASIC that serves as a means for (e.g., structure for) carrying out any one of the operations described, e.g., in conjunction with the FIGS. included herein. The components 1310 serve as an example of a means for processing. In various implementations, the components 1310 may provide and/or incorporate, at least in part, functionality described above for the components of controller 1008 of FIG. 10 or DSD controller 1204 of FIG. 12.

According to at least one example of the apparatus 1300, the processing components 1310 may include one or more of: circuit/modules 1320 configured for receiving optimization information; and circuits/modules 1322 configured for configuring a DSD.

The physical memory array 1304 may include one or more of: blocks 1330 configured to store data/code for receiving optimization information; and blocks 1332 configured to store data/code for configuring a DSD.

In at least some examples, means may be provided for performing the functions illustrated in FIG. 11 and/or other functions illustrated or described herein. For example, the means may include one or more of: means, such as circuit/module 1320 for receiving optimization information from a storage management device (e.g., storage management device 110 illustrated in FIG. 1; storage management device 310 illustrated in FIG. 3; storage management device 410 illustrated in FIG. 4; storage management device 510 illustrated in FIG. 5; storage management device 600 illustrated in FIG. 6; storage management device 800 illustrated in FIG. 8; or the combination of apparatus 900 and NVM 901 illustrated in FIG. 9) coupled to a plurality of pooled DSDs including the DSD (e.g., new DSD 430 illustrated in FIG. 4; DSD 530 illustrated in FIG. 5; DSD 1004 illustrated in FIG. 10; DSD 1200 illustrated in FIG. 12; or the combination of apparatus 1300 and NVM 1301 illustrated in FIG. 13) and at least one source DSD (e.g., any combination of DSDs 120, 130, and/or 140 illustrated in FIG. 1), wherein the optimization information includes at least one optimization learned by the at least one source DSD while coupled to the storage management device; and means, such as circuit/module 1322, for configuring the DSD (e.g., DSD 430 illustrated in FIG. 4; DSD 530 illustrated in FIG. 5; DSD 1004 illustrated in FIG. 10; DSD 1200 illustrated in FIG. 12; or the combination of apparatus 1300 and NVM 1301 illustrated in FIG. 13) to include the at least one device optimization.

In the examples of the FIGS. included herein, NAND memory is sometimes set forth as an exemplary NVM. In one aspect, the NVM may be flash memory or another suitable NVM, examples of which are noted above at the beginning of the Detailed Description section.

### Additional Aspects

At least some of the processing circuits described herein may be generally adapted for processing, including the execution of programming code stored on a storage medium. As used herein, the terms “code” or “programming” shall be construed broadly to include without limitation instructions, instruction sets, data, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

At least some of the processing circuits described herein may be arranged to obtain, process and/or send data, control data access and storage, issue commands, and control other desired operations. The processing circuits may include circuitry configured to implement desired programming provided by appropriate media in at least one example. For example, the processing circuits may be implemented as one or more processors, one or more controllers, and/or other structure configured to execute executable programming. Examples of processing circuits may include a general purpose processor, a digital signal processor (DSP), an ASIC, a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. At least some of the processing circuits may also be implemented as a combination of computing components, such as a combination of a controller and a microprocessor, a number of microprocessors, one or more microprocessors in conjunction with an ASIC and a microprocessor, or any other number of varying configurations. The various examples of processing circuits noted herein are for illustration and other suitable configurations within the scope of the disclosure are also contemplated.

Aspects of the subject matter described herein can be implemented in any suitable NVM, including NAND flash memory such as 3D NAND flash memory. More generally, semiconductor memory devices include working memory devices, such as DRAM or SRAM devices, NVM devices, ReRAM, EEPROM, flash memory (which can also be considered a subset of EEPROM), ferroelectric random access memory (FRAM), and MRAM, and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured. The semiconductor memory elements located within and/or over a substrate may be arranged in two or three dimensions, such as a two dimensional memory structure or a three-dimensional memory structure.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements. One of skill in the art will recognize that the subject matter described herein is not limited to the two-dimensional and three-dimensional exemplary structures described but cover all relevant memory structures within the spirit and scope of the subject matter as described herein and as understood by one of skill in the art.

The examples set forth herein are provided to illustrate certain concepts of the disclosure. The apparatus, devices, or components illustrated above may be configured to perform one or more of the methods, features, or steps described herein. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Aspects of the present disclosure have been described above with reference to schematic flowchart diagrams and/or schematic block diagrams of methods, apparatus, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

The subject matter described herein may be implemented in hardware, software, firmware, or any combination thereof. As such, the terms “function,” “module,” and the like as used herein may refer to hardware, which may also include software and/or firmware components, for implementing the feature being described. In one example implementation, the subject matter described herein may be implemented using a computer readable medium having stored thereon computer executable instructions that when executed by a computer (e.g., a processor) control the computer to perform the functionality described herein. Examples of computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

The various features and processes described above may be used independently of one another, or may be combined in various ways. All possible combinations and sub-combinations are intended to fall within the scope of this disclosure. In addition, certain method, event, state, or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example embodiments. The example systems and components described herein may be configured differently than described. For example, elements may be added to, removed from, or rearranged compared to the disclosed example embodiments.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

While the above descriptions contain many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents. Moreover, reference throughout this specification to “one embodiment,” “an embodiment,” “in one aspect,” or similar language means that a particular feature, structure, or characteristic described in connection with the embodiment is included in at least one embodiment of the present disclosure. Thus, appearances of the phrases “in one embodiment,” “in an embodiment,” “in one aspect,” and similar language throughout this specification may, but do not necessarily, all refer to the same embodiment, but mean “one or more but not all embodiments” unless expressly specified otherwise.

The terminology used herein is for the purpose of describing particular aspects only and is not intended to be limiting of the aspects. As used herein, the singular forms “a,” “an” and “the” are intended to include the plural forms as well (i.e., one or more), unless the context clearly indicates otherwise. An enumerated listing of items does not imply that any or all of the items are mutually exclusive and/or mutually inclusive, unless expressly specified otherwise. It will be further understood that the terms “comprises,” “comprising,” “includes” “including,” “having,” and variations thereof when used herein mean “including but not limited to” unless expressly specified otherwise. That is, these terms may specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may include one or more elements. In addition, terminology of the form “at least one of A, B, or C” or “A, B, C, or any combination thereof” or “one or more of A, B, or C” used in the description or the claims means “A or B or C or any combination of these elements.” For example, this terminology may include A, or B, or C, or A and B, or A and C, or A and B and C, or 2A, or 2B, or 2C, or 2A and B, and so on. As a further example, “at least one of: A, B, or C” or “one or more of A, B, or C” is intended to cover A, B, C, A-B, A-C, B-C, and A-B-C, as well as multiples of the same members (e.g., any lists that include AA, BB, or CC). Likewise, “at least one of: A, B, and C” or “one or more of A, B, or C” is intended to cover A, B, C, A-B, A-C, B-C, and A-B-C, as well as multiples of the same members. Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

As used herein, the term “determining” encompasses a wide variety of actions. For example, “determining” may include calculating, computing, processing, deriving, investigating, looking up (e.g., looking up in a table, a datastore, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

What is claimed is:

1. A data storage system, comprising:
a plurality of data storage devices each comprising a non-volatile memory (NVM); and
a storage management device configured to couple to each of the plurality of data storage devices and configured to:
receive optimization information from at least one source data storage device of the plurality of data storage devices, wherein the optimization information comprises at least one optimization learned by the at least one source data storage device while part of the data storage system; and
configure a new data storage device for the data storage system with the at least one device optimization.

2. The data storage system of claim 1:
wherein the NVM comprises a flash memory; and
wherein the at least one optimization comprises an optimization for a setting in a flash translation layer of the at least one source data storage device.

3. The data storage system of claim 2, wherein the at least one optimization comprises SLC/MLC information indicative of an allocation of both single-level cell (SLC) blocks and multi-level cell (MLC) blocks in the at least one source data storage device.

4. The data storage system of claim 2, wherein the at least one optimization comprises defragmentation information associated with the at least one source data storage device, the defragmentation information comprising at least one threshold indicative of a level at which the at least one source data storage device would initiate a defragmentation process.

5. The data storage system of claim 2, wherein the at least one optimization comprises internal random-access memory (RAM) configuration information associated with an internal RAM of the at least one source data storage device.

6. The data storage system of claim 5, wherein the internal RAM configuration information comprises an allocation of the internal RAM for storing at least one of:
logical-to-physical (L2P) table information;
defragmentation information;
host read information; or
host write information.

7. The data storage system of claim 1, wherein the storage management device is further configured to:
maintain configuration settings for coupling to the plurality of data storage devices; and
modify the configuration settings to replace at least one of the plurality of data storage devices with the new data storage device; and
wherein the at least one of the plurality of data storage devices to be replaced is the at least one source data storage device.

8. The data storage system of claim 7:
wherein the at least one optimization comprises a classification of data copied from the at least one source data storage device to the new data storage device,
wherein the storage management device is further configured to configure the new data storage device to store the data based on the classification, and
wherein the classification comprises an indication of hot data and cold data among the copied data.

9. The data storage system of claim 8, wherein the classification of the copied data comprises classifications for one or more logical block addressing (LBA) ranges associated with portions of the copied data, and wherein the storage management device is further configured to configure the new data storage device to store the copied data based on the classifications of the one or more LBA ranges.

10. The data storage system of claim 1, wherein the storage management device is configured to receive the optimization information from at least two source data storage devices of the plurality of data storage devices.

11. A method for use with a data storage system including a storage management device and a plurality of data storage devices each comprising a non-volatile memory (NVM), the method comprising:
receiving optimization information from at least one source data storage device of the plurality of data storage devices, wherein the optimization information comprises at least one optimization learned by the at least one source data storage device while part of the data storage system; and
configuring a new data storage device for the data storage system with the at least one device optimization.

12. The method of claim 11:
wherein the NVM comprises a flash memory;
wherein the at least one optimization comprises an optimization for a setting in a flash translation layer of the at least one source data storage device; and
wherein the at least one optimization comprises SLC/MLC information indicative of an allocation of both single-level cell (SLC) blocks and multi-level cell (MLC) blocks in the at least one source data storage device.

13. The method of claim 11:
wherein the NVM comprises a flash memory;
wherein the at least one optimization comprises an optimization for a setting in a flash translation layer of the at least one source data storage device; and
wherein the at least one optimization comprises defragmentation information associated with the at least one source data storage device, the defragmentation information comprising at least one threshold indicative of a level at which the at least one source data storage device would initiate a defragmentation process.

14. The method of claim 11:
wherein the NVM comprises a flash memory;
wherein the at least one optimization comprises an optimization for a setting in a flash translation layer of the at least one source data storage device; and
wherein the at least one optimization comprises internal random-access memory (RAM) configuration information associated with an internal RAM of the at least one source data storage device.

15. The method of claim 11, wherein the method further comprises:
maintaining configuration settings for coupling to the plurality of data storage devices; and
modifying the configuration settings to replace at least one of the plurality of data storage devices with the new data storage device; and
wherein the at least one of the plurality of data storage devices to be replaced is the at least one source data storage device.

16. The method of claim 15, wherein the at least one optimization comprises a classification of data copied from the at least one source data storage device to the new data storage device, and wherein the method further comprises:
configuring the new data storage device to store the data based on the classification, wherein the classification comprises an indication of hot data and cold data among the copied data.

17. A data storage system, comprising:
a plurality of data storage devices each comprising a non-volatile memory (NVM);
means for receiving optimization information from at least one source data storage device of the plurality of data storage devices, wherein the optimization information comprises at least one optimization learned by the at least one source data storage device while part of the data storage system; and
means for configuring a new data storage device for the data storage system with the at least one device optimization.

18. A data storage device, comprising:
a non-volatile memory (NVM); and
a processor coupled to the NVM and configured to:
receive optimization information from a storage management device coupled to a plurality of pooled data storage devices including the data storage device and at least one source data storage device, wherein the optimization information comprises at least one optimization learned by the at least one source data storage device while coupled to the storage management device; and
configure the data storage device to include the at least one device optimization.

19. The data storage device of claim 18, wherein the at least one optimization comprises SLC/MLC information indicative of an allocation of both single-level cell (SLC) blocks and multi-level cell (MLC) blocks in the at least one source data storage device.

20. The data storage device of claim 18, wherein the at least one optimization comprises defragmentation information associated with the at least one source data storage device, the defragmentation information comprising at least one threshold indicative of a level at which the at least one source data storage device would initiate a defragmentation process.
